(19) United States
(12) Patent Application Publication
(10) Pub. No.: US 2005/0044536 A1
(43) Pub. Date: Feb. 24, 2005

(54) Method and system for dynamic generation of Perl language debugging tool

(76) Inventors: Man K. Kwong, Naperville, IL (US); Lai-Cherng Suen, Naperville, IL (US)

Correspondence Address: Carl A. Giordano, Esq.;Duane Morris LLP, 380 Lexington Avenue, New York, NY, 10168, US

(21) Appl. No.: 10/644,556

(22) Filed: Aug. 19, 2003

(51) Int. Cl. G06F 9/44

(52) U.S. Cl. 717/128

(57) ABSTRACT

A method and system for dynamically generating a Perl-language debugging tool that monitors selected ones of a plurality of quantities in a Perl-language program is disclosed. The method includes the steps of selecting at least one of the quantities, identifying each reference to the selected at least one quantity, including an operation to the said selected quantity at selected ones of the references to the quantity, and creating a second software package from said first software package containing the included operations. In another aspect of the invention, the selected quantity or quantities may be monitored between specified line ranges or specified reference conditions.

### FIELD OF THE INVENTION

This application is related to the field of software development and more specifically to a method for dynamically generating real-time Perl-language debugging versions of a Perl-language program.

### BACKGROUND OF THE INVENTION

The Perl-programming language is a scripting language that has become very successful in state-of-the-art software development. It has been used in many telecommunication and web-based software. It works very much like an interpreted language, although in reality the source program is first compiled. Unlike traditional compiled languages, such as C and C++, compilation is not initiated by the user as a separate step. Instead, when the source file is invoked as a command, compilation is automatically done behind the scene as a first step before the program is actually executed. In practice, a PERL program runs about ten times slower than an equivalent C or C++ program (but many times faster than a true interpreted language, such as a Unix shell script). Even so, Perl-programs run fast enough (indeed very much so) to be usable in many practical applications. They make up for this disadvantage by being much easier to develop than C and C++ programs. Increasingly, more and more large-scale programs (consisting of thousands of lines of code) have been written in Perl.

Because of the growing popularity of Perl-language software, an efficient method to debug Perl-programs becomes very desirable. One prior art is to use a powerful Perl-debugger available in the standard distribution of the Perl-language. This debugger has the usual features of a symbolic debugger (like the well-known dbx or gdb for C and C++), such as allowing the user to:
set break points (execution temporarily stops at some specified line number)
when execution is temporarily stopped, examine or modify values of various variables
step through one command at a time
set watch points (execution temporarily stops whenever the value of a specified variable changes).

Undoubtedly, the Perl-debugger is an invaluable tool in the development and maintenance of Perl-software in a majority of situations.

Yet, it still has certain shortcomings. One of these is that when executed under the debugger, the program is no longer running in real time. For one reason, the debugger causes the program to run several times slower than when it is run without the debugger. Then if one wants to get any debug information, the program must be temporarily stopped at various break points, causing interruptions in the otherwise continuous execution of the program. Some programs, especially those used in telecommunication software, will not function correctly if they are not run in real time. There are further situations in which the Perl-debugger is not convenient or suitable for use. For example, one has to either guess where is a good place to add the debugging statements or go through the entire program to look for suitable locations.

One conventional technique often used for debugging such programs is to manually insert debugging statements in appropriate locations of the program, such as statements to print values of specified variables, or timing information. This technique is time consuming for large programs because one has to go through every line of the program to decide where it is appropriate to add the debugging statements. It is also error prone as one can miss a good place to add a debugging statement and also because often one forgets to delete some of the added statements after debugging is done.

Furthermore, this manual process requires tedious and time-consuming typing. Many variables used in a complicated program represent objects having very complex data structures. Although there are known ways to display the values of such variables or quantities in an easy-to-read format, having to type all the required commands manually as debugging statements is a formidable task that most developers either do not have the necessary skills or know-how to do properly or are not willing to spend the time to go through the process.

In any case, after printing the values of some selected variables, and determining that they are acceptable, a user may then decide to print values of other variables in the next round of debugging. In order to do that, the user must review the entire program to delete the earlier debugging statements and insert new ones.

Then again, after the debugging process is completed, the user must review the program to insure that all inserted debugging statements are removed before the program can be resubmitted as production software.

To solve the problem of tedious typing of debugging statements for future debugging processes, some developers may choose to include debugging statements as part of the original program, either in the form of comment lines or in the form of conditional statements that are turned on when a certain debug flag variable is given certain values. In the first case, to enable debugging, the commented debugging statements are turned on by removing the beginning comment character. After debugging is finished, the comment character is restored for each debugging statement. In the second case, to enable debugging, a single statement setting a debug flag variable is inserted. The program then is operable to execute debugging states that would otherwise be bypassed or avoided.

There are at least two disadvantages of both of these methods or techniques. The extra debugging statements make the program longer and much harder to understand and to maintain. They also cause the program to run slower and less efficiently. Although the Perl-interpreter ignores comment lines, an excess number of comment lines can still use up some time, no matter how little, for the interpreter to read in and discard comment lines during the initial compilation phase. (For compiled languages like C and C++, comment lines only affect compilation time but not executing time.)

Accordingly, a need for a method and system that allows for the dynamic development a Perl-debugging tool that is preferably operable in real-time is desirable.

### SUMMARY OF THE INVENTION

A method and system for dynamically generating a Perl-language debugging tool that monitors selected ones of a plurality of quantities in a Perl-language program is disclosed. The method includes the steps of selecting at least one of the quantities, identifying each reference to the selected at least one quantity, including an operation to the said selected quantity at selected ones of the references to the quantity, and creating a second software package from said first software package containing the included operations. In another aspect of the invention, the selected quantity or quantities may be monitored between specified line ranges or specified reference conditions.

### BRIEF DESCRIPTION OF THE DRAWINGS

FIG. 1 illustrates a flow chart of an exemplary process for how the real-time Perl-debugger tool works in accordance with the principles of the invention;

FIG. 2 illustrates a flow chart of an exemplary process for development the new debugging program from a given source program in accordance with the principles of the invention;

FIG. 3 illustrates an exemplary interface for establishing parameters of the debugging tool in accordance with the principles of the invention; and

FIG. 4 illustrates a system for executing the processing shown in FIGS. 1-3.

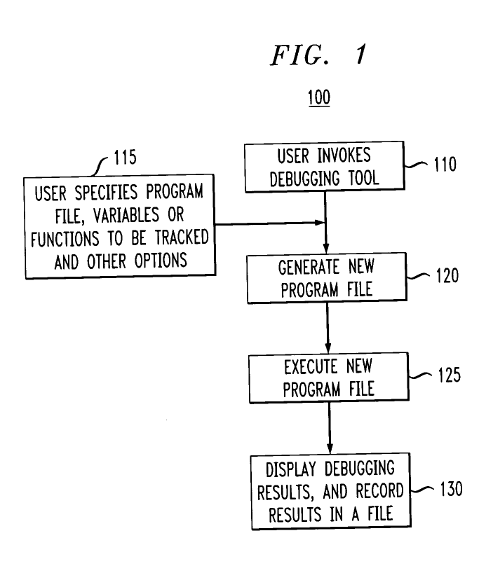

It is to be understood that these drawings are solely for purposes of illustrating the concepts of the invention and are not intended as a definition of the limits of the invention. The embodiments shown in FIGS. 1-4 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

FIG. 1 illustrates a flow chart of an exemplary process 100 for generating a real-time Perl-debugger tool in accordance with one aspect of the invention. In this illustrated aspect, a user may invoke the real-time debugging tool using well-known methods at block 110. For example, a user may access the real-time debugging tool disclosed by entering the tool's executable file name using an input device, such as a keyboard. Or a user may access the real-time debugging tool executable file using a Graphical User Interface (GUI) and a pointing device, such as a computer mouse, light-pen, touch screen, etc.

At block 115, a user may then select a Perl-language based executable program file and select constants, variables, vectors, arrays, functions or similar quantities that are desired to be monitored. At block 120, a new program file is generated containing statements or operations that make reference or refer to the quantities selected. For example, a reference to a quantity may be when memory locations containing the quantity is read or written into. At block 125, the generated program may then be executed. The monitored quantities may then be displayed or recorded in a device for subsequent or later viewing.

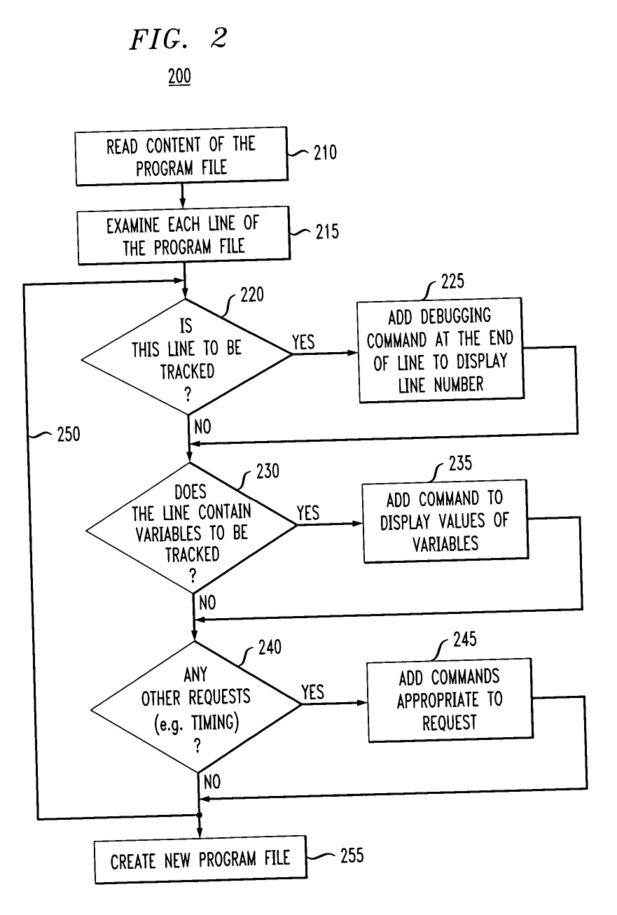

FIG. 2 illustrates a flow chart of an exemplary process 200 for generating a new program file in accordance with the principles of the invention. In this illustrated embodiment, the contents of the selected file are read at block 210. At block 215, each line of the selected program file is then examined. For each line, a determination is made, at block 220, whether a selected program line is to be tracked. If the answer is in the affirmative, then a debugging command is appended to the end of the line to indicate that the display line is being tracked. A determination is then made at block 230, whether the selected program line contains a variable that is designated as being monitored. If the answer is in the affirmative, then a command is added to the end of the line, at block 235, to display or record the value of the monitored variable. A determination is then made at block 240, whether the selected program line contains information regarding other desired characteristics. For example, the determination at block 240 may determine whether time execution between selected lines is desired. If the answer is in the affirmative, then appropriate commands are appended to the end of the selected program line.

A determination is made whether all of the program lines have been examined. If the answer is negative, the processing selects the next program line, represented by line 250, and subjects the selected next program line to the determinations at blocks 220, 230 and 240. After all the program lines are examined, a new program is recorded at block 255.

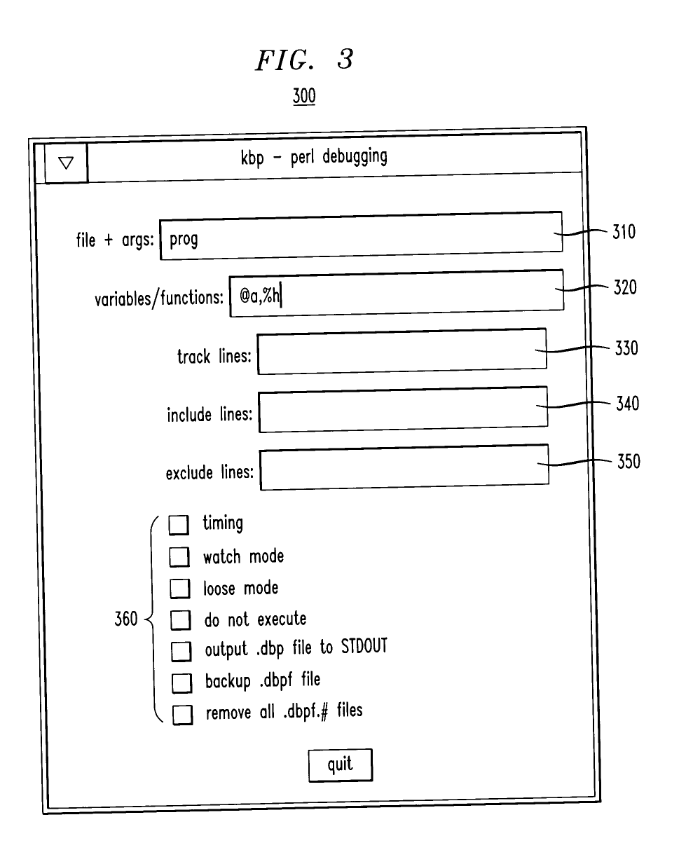

FIG. 3 illustrates an exemplary user interface 300 in accordance with one aspect of the present invention. In one embodiment, a user may invoke the real-time debugging tool by typing the command tool file name on a computer terminal. The use may then enter an alphanumeric character string in the “file+arg” field 310, which specifies or designates a program file. In addition, any other arguments that need be provided to the program when it is executed are provided in the entry field. The user may then enter at least one quantity, e.g., variable or function name, in variable/functions field 320 that the user desires to track or monitor. In one aspect, a user may track all variables whose names contain a certain pattern, such as all variables that start with the letter “a.” The user may then enter a range of program lines, in field 330, to which he/she wishes to limit the monitoring of the desired quantity, e.g., variable or function names. Conversely or in addition the user may enter a range of program lines, in field 340, to which he/she wishes to specifically exclude monitoring of the desired variable or function names. In a preferred embodiment, and used as a default condition, all the lines of the program are monitored for the desired variable or function name.

The user is further provided with optional setting, represented as 360, using a single button for each setting to invoke, for example, timing characteristics between designated locations within the program. Other optional settings shown include “watch mode,” which specifies that monitoring information regarding selected variables is displayed only if the value of the variable has been altered. Similarly, “loose mode” allows a user to specify that array and hash variable be displayed in a format that is easier to read, but that uses more space. The “do not execute” operation instructs the debugging tool not to execute the newly generated program. The program may be run at a later time as a standalone program. The “output” button specifies that the content of the newly generated program be displayed. The “backup” option specifies that older versions of the newly generated program be stored and the “remove all” option specifies all the newly generated programs, except the most recent, be erased. In another aspect (not shown), a reference condition, such as “read only” or “write only” may be specified. As would be recognized by those skilled in the art, the user interface presented is only one example of such an interface and it would be well within the knowledge of such skilled artisans to create user interfaces with significantly more detail and complexity. However, such interfaces are contemplated to be within the scope of the invention.

An example of the dynamic generation of debugging statements is shown using a Perl-program as follows:

for ($i; $i <= 100; $i++) {
$sum += $i;
}
print $sum;
@array = (‘red’,‘orange’,‘yellow’,‘green’,‘blue’);
%hash = {‘lemon’ => ‘yellow’,‘violet’ => ‘blue’,‘rose’ => ‘red’};

In this exemplary program, value of the numbers between 1 and 100 is determined by incrementing a counter, i.e., $i, in a “for” loop and accumulating the current value of the counter with previous values in an accumulator, i.e., $sum. At the conclusion of the “for” loop, the accumulated total is printed. The program also depicts an array, i.e., @array, defined with the colors “red,” “orange,” “yellow,” “green,” and “blue,” and a hash array, i.e., % hash. The @array and the % hash values are added here to illustrate that the invention can selectively add appropriate debugging statements according to which selected quantity or quantities are specified by the user.

One skilled in the art would recognize, the example program illustrates three different data types in the Perl-programming Language. Scalar data types are those names that start with a dollar sign, i.e., $, such as $i and $sum. Scalar data types in Perl-language are similar to ordinary variables in the “C” programming language and each scalar name contains a single value. Array data types are those names that start with “@,” e.g. @array. An array is a collection of several “scalar variables” that all have the same root name. Each name may further be indexed by using a number, e.g. $array[0], $array[1], etc. Hash data types are similar to an array but rather than using a number when referring to an individual member, e.g., 1 inside [1], a hash uses a string of characters to refer to a member. When using hash braces, i.e., { }, rather than square brackets, i.e., [ ], are used. In the above example, $hash{lemon} is an individual member of the hash $hash and it contains the value ‘orange’. The use of a hash variable is much more flexible and useful than an array variable. However, the flexibility of using a hash is obtained at the expense of efficiency. Hence, a program runs slightly slower when a hash variable is used rather than an array variable.

A debugging tool may then be dynamically generated in one aspect of the invention, wherein the quantity, $sum, is monitored as follows:

```
########### generated program for tracking $sum ##################
    #!/opt/exp/bin/perl
    use myDumper; unlink $myDumper::_dbpf = ‘tdb.dbpf’;
    for ($i; $i <= 100; $i++) {
    $sum += $i; eval _d ‘sum’;
    }
    print $sum; eval _d ‘sum’;
    @array = (‘red’,‘orange’,‘yellow’,‘green’,‘blue’);
    %hash = {‘lemon’ => ‘yellow’,‘violet’ => ‘blue’,‘rose’ => ‘red’};
```

In this case, the function “eval_d ′sum”’ is incorporated into the program for each occurrence of the monitored value, i.e., $sum. Thus, in each case that a reference is made, either to read or write, to monitored variable “$sum” the function “eval_d” captures the desired data and records it for subsequent processing and review. The function or operation “eval” is well known to those skilled in the art of the Perl-programming language and need not be discussed in detail herein. The operation “eval_d” produces an output put from the provided input name, in this case “sum” which is then acted on by the standard Perl language “eval” function or operation. The function “_d” essentially generates the information needed for the “eval” function to access and store the value of the desired variable.

A second example of the present invention is now shown for the tracking or monitoring access to the array referred to as “@array.”

```
######### generated program for tracking @array ##################
    #!/opt/exp/bin/perl
    use myDumper; unlink $myDumper::_dbpf = ‘tdb.dbpf’;
    for ($i; $i <= 100; $i++) {
    $sum += $i;
    }
    print $sum;
    @array = (‘red’,‘orange’,‘yellow’,‘green’,‘blue’); eval _d ‘.array’;
    %hash = {‘lemon’ => ‘yellow’,‘violet’ => ‘blue’,‘rose’ => ‘red’};
```

Similar to the operation shown in the first example, the debugging tool of the present invention creates a new program and inserts the function “eval_d” at each reference to the desired monitored value.

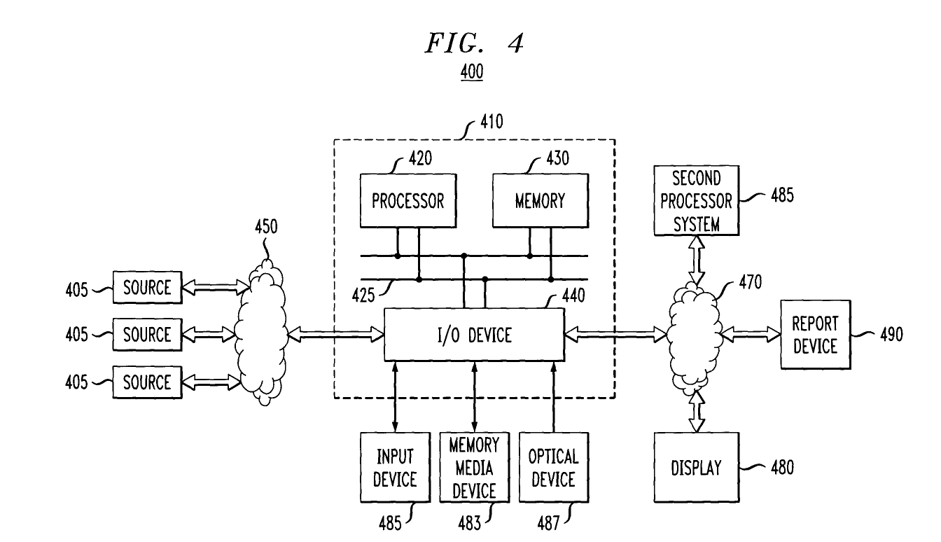

FIG. 4 illustrates a system 400 for implementing the principles of the invention as depicted in the exemplary processing shown herein. In this exemplary system embodiment 400, input data is received from sources 405 over network 450 and is processed in accordance with one or more software programs executed by processing system 410. The results of processing system 310 may then be transmitted over network 470 for viewing on display 480, reporting device 490 and/or a second processing system 495.

Specifically, processing system 410 may be representative of a handheld calculator, special purpose or general purpose processing system, desktop computer, laptop computer, palm computer, or personal digital assistant (PDA) device, etc., as well as portions or combinations of these and other devices that can perform the operations illustrated herein and includes one or more input/output devices 440 that receive data from the illustrated source devices 405 over network 450. The received data is then applied to processor 420, which is in communication with input/output device 440 and memory 430. Input/output devices 440, processor 420 and memory 430 may communicate over a communication medium 425. Communication medium 425 may represent a communication network, e.g., ISA, PCI, PCMCIA bus, one or more internal connections of a circuit, circuit card or other device, as well as portions and combinations of these and other communication media.

In one embodiment, processor 420 may include code which, when executed, performs the operations illustrated herein. The code may be contained in memory 430, read or downloaded from a memory medium such as a CD-ROM or floppy disk represented as 483, or provided by manual input device 485, such as a keyboard or a keypad entry, or read from a magnetic or optical medium 487 which is accessible by processor 420, when needed. Information items provided by input device 483, magnetic medium 485, and/or optical medium 487, may be accessible to processor 420 through input/output device 440, as shown. Further, the data received by input/output device 440 may be immediately accessible by processor 420 or may be stored in memory 430. Processor 420 may further provide the results of the processing shown herein to display 480, recording device 490 or a second processing unit 495 through I/O device 440.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operation illustrated herein may be performed sequentially or in parallel using different processors to determine specific values. Processor system 410 may also be in two-way communication with each of the sources 405. Processor system 410 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 450 and 470 may also be internal networks, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, although the present invention is discussed with regard to the “eval_d” operation or function, it would be recognized by those skilled in the art that the present invention may use similar functions such as a “_k( )” for line number tracking, which uses the standard “caller( )” function and a “_t( )” function, which uses the standard PERL language “Time::HiRes” module for recording time differences. It is expressly intended that all combinations of those elements that perform substantially the same function in substantially the same way to achieve the same results are within the scope of the invention. Substitutions of elements from one described embodiment to another are also fully intended and contemplated.

1. A method for monitoring at least one quantity in a Perl-software package containing a plurality of quantities comprising the steps of:
selecting at least one of said quantities;
identifying each reference to said selected at least one quantity;
including an operation to record said selected quantity at selected ones of said references to said quantity; and
creating a second software package from said first software package containing said included operations.

2. The method as recited in claim 1, wherein the step of selecting at least one of said quantities further comprises:
viewing said plurality of quantities; and
selecting at least one of said quantities.

3. The method as recited in claim 1, wherein said quantities are selected from the group consisting of: scalar, constant, variable, vector, array, hash, function.

4. The method as recited in claim 1, wherein said operation further comprises the steps of:
receiving said selected at least one quantity; and
recording said at least one quantity when said quantity is referenced.

5. The method as recited in claim 1, wherein said selected references are identified from the group consisting of: line ranges, variables, reference condition.

6. The method as recited in claim 4, wherein the step of storing further comprises the step of:
recording said quantity when said quantity is altered.

7. The method as recited in claim 1, further comprising the step of:
printing the recorded references of said quantities.

8. The method as recited in claim 1, wherein said operation is operable to determine a time difference between selected quantities.

9. The method as recited in claim 1, wherein said operation is selected from the group consisting of: eval _d, _k, _t.

10. A system for monitoring at least one quantity in a Perl-software package containing a plurality of quantities comprising:
a processor in communication with a memory, said processor operable to execute code for:
selecting at least one of said quantities;
identifying each reference to said selected at least one quantity;
including an operation to record said selected quantity at selected ones of said references to said quantity; and
creating a second software package from said first software package containing said included operations.

11. The system as recited in claim 10, wherein for selecting at least one of said quantities said processor is further operable to execute code for:
viewing said plurality of quantities; and
selecting at least one of said quantities.

12. The system as recited in claim 10, wherein said quantities are selected from the group consisting of: scalar, constant, variable, vector, array, function.

13. The system as recited in claim 10, wherein said processor is further operable to execute code for:
receiving said selected at least one quantity; and
recording said at least one quantity when said quantity is referenced.

14. The system as recited in claim 10, wherein said selected references are identified from the group consisting of: line ranges, variables, reference conditions.

15. The system as recited in claim 14, wherein said processor is further operable to execute code for:
recording said quantity when said quantity is altered.

16. The system as recited in claim 10, wherein said processor is further operable to execute code for:
printing the recorded values of said quantities.

17. The system as recited in claim 10, wherein said code is stored in said memory.

18. The system as recited in claim 10, further comprising:
a device for receiving information from and transmitting information to said processor.

19. The system as recited in claim 10, wherein said processor is further operable to execute for:
determining a time difference between selected quantities.

20. The system as recited in claim 10, wherein said operation is selected from the group consisting of: eval _d, _k, _t.
